(19) United States
(12) Patent Application Publication
(10) Pub. No.: US 2011/0309938 A1
(43) Pub. Date: Dec. 22, 2011

(54) Method for providing a uniform and comprehensive programming interface for an electronic device

(76) Inventors: Donald Olsen, Brookhaven, NY (US); Henry B. Wallace, Fincastle, VA (US)

(21) Appl. No.: 13/134,637

(22) Filed: Jun. 13, 2011

Related U.S. Application Data
(60) Provisional application No. 61/397,416, filed on Jun. 11, 2010.

(51) Int. Cl. G08B 17/00

(52) U.S. Cl. 340/584

(57) ABSTRACT

A method of providing an electronic monitoring or controlling device with a uniform and comprehensive programming interface as a means for accessing, either individually or in subgroups, various parameters, for the purposes of programming device operation, performing system diagnostics, or for activation, deactivation, selection or changing of other device functions. Said monitoring or controlling device includes user input means such as an individual switch or a plurality of switches, user output means such as a single or multi-digit digital readout, a microcontroller, and various electronic devices and sensors necessary for the device to perform its desired function. Said uniform and comprehensive programming interface provides a means for utilization of the aforementioned user input and output means for selecting, changing and displaying parameter choices, while at the same time, because of its architecture, being inherently secure.

### CROSS-REFERENCE TO RELATED APPLICATIONS

This application is related to U.S. Provisional Application Ser. No. 61/397,416, which was filed on Jun. 11, 2010, and is entitled “Improvements In Operation Of Monitoring/Control Systems Such As Refrigeration Monitoring and or Control Devices, Including Walk-in Monitoring and or Control Devices Which Incorporate Compartment Light Control Function”, the disclosure of which is hereby incorporated by reference and on which priority is hereby claimed.

### BACKGROUND OF THE INVENTION

1. Field of the Invention

The present invention relates to electronic circuits and methods for monitoring and controlling an electrical device, such as an appliance, and more particularly, a refrigerator or freezer, connected thereto.

The present invention can be applied to any electronic monitoring or controlling device which provides and utilizes both a means and a method for accessing various parameters, settings and selections of which will affect device operation. While benefit can be realized in virtually any monitoring or controlling device, particular benefit is best provided in devices with both limited user input means for selection and changing of parameters, and limited user output means for displaying resultant selections and changes of parameters. Limited user input means would typically consist of a single switch or a small plurality of switches with the most common switch type being of a momentary, press to activate configuration. Limited user output means would typically consist of a single readout means or a small plurality of readout means, typical readout means being a seven segment display, LED or LCD or other devices of which are capable of providing display of alphanumeric characters.

2. Description of the Prior Art

Common devices incorporating a menu of parameter choices as a means of configuring device operation, and limited user input and user output means such as previously described, are devices designed for monitoring and or controlling of environmental conditions such as temperature, humidity, pressure, time and the like. A more defined example of a typical device meeting the criteria of incorporating a menu of parameter choices and offering a limited number of user input and user output means would be a device such as a temperature alarm. In normal operation where temperature alarms are performing their intended monitoring functions, extensive user input and user output functions are not required. Typically, all that is required for the device to perform its intended function is 1) a user input means, consisting of a very small plurality of two or three switches, provided for purposes such as responding to or resetting an alarm condition, for performing test functions or for programming, and 2) a user output means, consisting of a small plurality of display devices such as a two, three or four digit seven segment displays provided for purposes such as displaying temperatures and other monitored conditions.

Specifically, in a device such as a temperature alarm which utilizes both a menu of parameter choices as a means of configuring device operation, and which also provides a limited user input and user output means, the invention provides a uniform and comprehensive interface allowing for easy access to parameter choices, either individually or in subgroups, of all available parameters for the multiple purposes of programming device operation, performing system diagnostics, or for activation, deactivation, selection or changing of other device functions.

Electronic devices utilized for the monitoring or controlling of various environments or conditions, such as the temperature within a refrigerator or freezer, typically incorporate or provide a plurality of user selectable variables or parameters, often referred to as a programming menu, as a means of configuring these parameters so as to achieve desired operation. Access to this programming menu has typically been made in a variety of ways, depending on the user input means, user output means and designed method of access.

One example of programming menu access would be the commonly available provision of a dedicated programming button, often identified and labeled with terms such as “PRG” (program) or “SET”, the pressing of which would provide access to some or all of the available programming parameters. In the typical scenario, when this button is pressed, the electronic device goes into “program mode”, sequentially displaying prompts to identify the parameter to be viewed or changed and then displaying the current value of the respective parameter, which, if desired, can then be changed by the user through utilization of other provided and appropriately labeled buttons on the device.

On a device such as a temperature alarm which is designed in this manner, pressing of the “SET” button might typically cause the display output means to momentarily display the first of many programmable parameters, for example the word “HI”, corresponding to the high setpoint of the alarm (a temperature above which said HI setpoint would indicate abnormal operation), followed by a display of the currently selected HI setpoint temperature, the value of which can then be changed through utilization of other provided buttons which would allow the setpoint value to be moved upward or downward in accordance with desired operation. Following selection of a desired HI setpoint value, pressing of the “SET” button again will typically move the programming menu to the next listed parameter and the procedure is repeated until all parameter values (perhaps dozens) have been reviewed or adjusted so as to obtain desired device operation.

Disadvantages to this approach are threefold.

First, provision of a button so labeled can invite tampering by unauthorized personnel. In the example of a temperature alarm for a commercial refrigerator or freezer, which typically is designed to alert personnel by sounding an audible alarm if temperatures rise above or fall below certain selected limits, unauthorized personnel who may be annoyed by these annunciations could utilize the “SET” button to change setpoints so that the alarm would sound much less frequently, if at all, resulting in a situation where integrity of stored perishables could be compromised. As a result, such an approach is not inherently secure. While it is possible to provide a means for locking or unlocking of programming access through procedures such as pressing or holding a designated combination of buttons for a period of time, this designated combination and procedure is typically unique to the application and is not part of a uniform programming approach, making the procedure more difficult and cumbersome to utilize.

Second, such an architecture does not provide for direct access to a given parameter or to groups of parameters pre-configured as presets. Rather, when the program menu is accessed in the manner as so described, the electronic device typically directs the user to the first parameter in the program menu and then all other parameters in the program menu are accessed sequentially. Therefore, in a scenario where it is desired to change just one parameter, the user might first have to scroll through many undesired parameters in order to access the desired parameter to edit. This can be increasingly cumbersome if there are a large number of parameters and access to the desired parameter is located deep in the programming menu. Such a scenario makes it difficult to access the desired parameter and is more prone to error.

Third, particularly if a device offers more than one programming menu, such as a menu of lesser used parameter adjustments or a menu of diagnostics for testing or troubleshooting, access can be cumbersome, often necessitating procedures such as pressing various combinations of buttons or holding of various buttons for designated periods of time so as to gain access to the desired programming menu. Again, this procedure can be cumbersome and confusing to utilize, is prone to error and is not part of a uniform access programming approach.

On electronic devices which do not have dedicated programming buttons, another commonly utilized approach is to press and/or hold various designated combinations of buttons, sometimes for specified periods of time as previously described, as a means of accessing one or more programming menus, but again, this approach suffers from the same shortcomings as earlier disclosed in that there is no direct access to specific parameters or to groups of parameters pre-configured as presets, and, particularly if there are multiple programming menus, there is no unified programming approach and attempting to access these multiple programming menus can be cumbersome, confusing and prone to error.

It is, therefore, desirable to provide a uniform and comprehensive programming interface which consistently utilizes the same architecture and procedure for accessing all possible configurable programming menus, all individual parameters and all groups of parameters configured as presets, is easy to use and is less prone to error, and because of its architecture, is inherently secure.

### OBJECTS AND SUMMARY OF THE INVENTION

Accordingly, on electronic devices with limited user input and output means such as a temperature alarm, it is an object of the invention to provide a programming interface through which user input and output means may be used to easily access all available programming parameters.

It is another object of the invention to provide a programming interface which is uniform in its architecture as a means of accessing all available programming parameters.

It is yet another object of the invention to provide a programming interface which is comprehensive in its architecture as a means of accessing all available programming parameters.

It is still another object of the invention to provide a programming interface which will allow for direct access to single or multiple parameter addresses (defined below) which can affect entire device operation.

It is a further object of the invention to provide a programming interface which will allow for direct access to single or multiple groupings of individual parameters, parameters contained within a grouping to be linked together and pre-configured, and each grouping accessible by a unique parameter address for the group, the unique parameter address of the group to function as a preset for device operation.

It is yet a further object of the invention to provide a programming interface which will allow for direct access to single or multiple groupings of individual parameters, parameters contained within a grouping to be linked together and individually configurable by a unique parameter address for each parameter contained within the group, as a means of programming device operation.

It is still a further object of the invention to provide a programming interface which will allow for direct individual access to any individual parameter contained within a group of configurable parameters as a means of programming or changing the individual parameter.

It is still another object of the invention to provide a programming interface which allows for easy access to and management of a large number of individual or groups of parameters which can affect entire device operation, a large number of individual or groups of parameters pre-configured as presets, and a large number of individual or groups of parameters which are configurable.

It is yet another object of the invention to provide a programming interface, which, by its architecture, is inherently secure.

All of the above objectives are incorporated into the invention and will function in a manner as determined by software and hardware design as described in the detailed description of the preferred embodiments.

The present invention, therefore, comprises employing an alphanumeric interface as a method for uniformly and comprehensively accessing all of the individual parameters or groups of parameters contained within the electronic device. As disclosed, it is worth noting that other non-alphanumeric symbols may be created or utilized as well, but in the preferred embodiment, alphanumeric symbols are used because they are familiar to the user and are easily represented on devices such as seven segment displays. Therefore, when the invention is so employed, rather than going directly into a programming menu when program mode is accessed, the alphanumeric programming interface is instead accessed, with a further method for then accessing an alphanumeric value, identified as a parameter address, which corresponds to the respective individual parameter or group of parameters the user wishes to select.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a representative diagram of the physical layout of the user interface of the present invention.

FIG. 2 is a flow chart showing the relevant functional operations of the apparatus of the present invention.

FIG. 3 is a representative block diagram of the device electronics of the present invention.

### DETAILED DESCRIPTION OF THE PREFERRED EMBODIMENTS

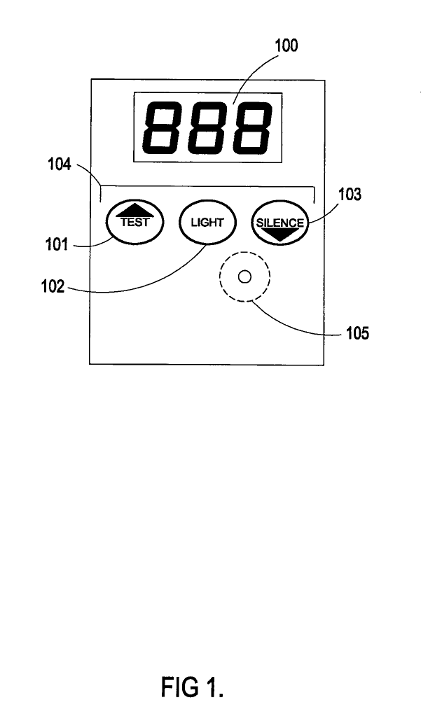

FIGS. 1, 2 and 3 will be utilized to describe the preferred embodiments of the invention. While the invention will be described in connection with the preferred embodiments, the description is not intended to limit the invention to these embodiments. On the contrary, it is intended to cover all alternatives, modifications and equivalents as may be included within the scope and spirit of the invention as defined by the claims.

Specific to a device such as a temperature alarm, and as previously disclosed, temperature alarms will typically have a small plurality of user input means such as three momentary buttons, and a small plurality of user output means such as three seven segment displays. As well, it is common for these types of devices to provide an audible annunciator such as a piezo or magnetic buzzer as a means of providing audible annunciation when alarm conditions occur. When in “RUN” mode, corresponding to when the device is performing its intended operation, the user input means is utilized to address device functions such as silencing an annunciation in an alarm condition, and the user output means is utilized to display monitored conditions such as temperature or alarm conditions such as “HI” if a high temperature alarm occurs.

In order to access the programming interface so as to enter “PROGRAM” mode, while a dedicated “SET” button may be provided for the purpose of accessing the programming interface, and a separate display may even be provided to display various programming choices, in the preferred embodiment, these same input and output means as employed in “RUN” mode are utilized to access, select, adjust and display parameter addresses when in “PROGRAM” mode. Therefore, when so configured, numerous procedures may be employed as a means of accessing the programming interface. Some possibilities may include procedures such as pressing and holding of an individual button for a predetermined period of time, pressing and holding a combination of buttons for a predetermined period of time, pressing and holding a button while momentarily pressing another button, or any of other numerous possibilities, the selected one of which is defined in the relevant operating code of the alarm. Regardless of the procedure employed, in the preferred embodiment, a uniform method is always utilized to access the programming interface as this minimizes confusion and renders the system less prone to error.

Specifically, referring to FIG. 1, central to the operation of the device is the user interface, preferably having a three digit display output means 100 and a three button input means 104. In the preferred embodiment, the buttons in the three button input means 104 provide multiple functionality depending on the operational mode of the device. When the temperature alarm is in “RUN” mode and is performing normal intended monitoring operations, individual button functions are as follows: A “Test/Up” button 101 is utilized to initiate simple functional device testing procedures as well as automatically displaying various parameter settings. A “Light/Select” button 102 is used as an on-off switch for compartment lighting control in an environment such as a walk-in cooler or freezer, the function and scope of which is not relevant to the present invention, and a “Silence/Down” button 103 is used as a means of acknowledging an alarm when it occurs as well as silencing of audible alarm annunciation. Audible alarm annunciation is provided by a piezo or magnetic type buzzer 105 which is recessed behind the faceplate as indicated by the dotted circle in FIG. 1 and annunciates audibly through a provided hole as indicated by the smaller, centrally placed, solid circle.

When the temperature alarm is in “PROGRAM” mode, the functionality of these same identified buttons is changed in the following manner: The “Test/Up” button 101 becomes the “scroll up” button and the “Silence/down” button 103 becomes the “scroll down” button. These identified buttons are then utilized to scroll up or down through available alphanumeric values, these values either corresponding to specific parameter addresses, or corresponding to various parameter values available within a given parameter address. Simultaneously, the “Light/Select” button 102 becomes a Select button, used to confirm a selected parameter address or value.

Regarding parameter addresses, in the preferred embodiment, parameter addresses are identified by numeric values, as this approach is intuitive and offers a large number of available possible parameter addresses. On a three digit display, a range from −99 to 999 can be utilized, providing 1099 possible parameter address locations, far in excess of what would typically be required for device programming. Each parameter so addressed corresponds to either a single operational setting of the device, a group of single operational settings of the device linked together and pre-configured as a preset, a setting which can affect entire device operation, a diagnostic function such as testing certain device functionality, or a function for some other undisclosed purpose.

This aspect of a large number of choices is part of what makes utilization of the programming interface inherently secure. In most common applications, a usable number of parameter addresses might typically be ten to fifty choices. In the preferred embodiment, operating code would be designed so that selecting an unused parameter address would automatically return the alarm to “RUN” mode, thus making the unit resistant to tampering.

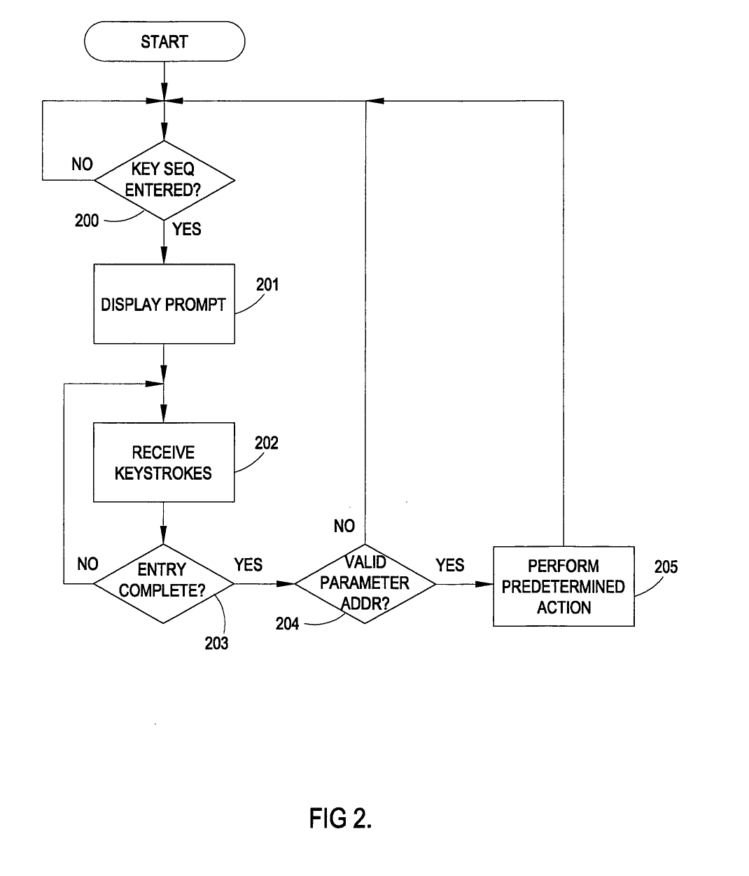

To access “PROGRAM” mode, in the preferred embodiment, while pressing and holding the “Silence/Down” button 103, the “Test/Up” button 101 is momentarily pressed. This action causes the alarm to signal that the programming interface has been accessed, such signaling including momentary activation of the piezo or magnetic type buzzer 105 and momentary display of identified characters indicative of program mode access in the form of three question marks on the three digit display output means 100 (which question marks may be formed acceptably on a seven segment display, as is known to persons skilled in the art). This action is further indicated on the flow chart of FIG. 2 as the decision box “Key Seq Entered?” 200.

Once program mode is initiated, the alarm then displays the number “0” (zero) on the three digit display output means 100, and then waits in that condition for a predetermined period of time, awaiting a response from the user. On the flow chart of FIG. 2, this condition is indicated by the box labeled “Display Prompt” 201. The purpose of waiting for a predetermined period of time is both to afford the user the opportunity to select a particular parameter address, while simultaneously ensuring that the alarm will automatically “timeout” and will return to “RUN” mode if the response isn't forthcoming in the allotted period of time. It is necessary to note that such timeout conditions are implemented throughout “PROGRAM” mode whenever a procedure is followed by a requisite user response. For the sake of clarity and brevity, the flowchart includes only the detail relevant to parameter addressing, and other details such as proper handling of timeout conditions which are well know to persons skilled in the art are omitted.

Once the programming interface has been accessed, and the “Display Prompt” 201 condition has been reached, this is when the function of the three button input means 104 changes from “RUN” mode to “PROGRAM” mode as previously described. The “Test/Up” button 101 and the “Silence/Down” button 103 are now utilized to scroll to the desired parameter address so as to access and perform the selected programming function. On the flow chart of FIG. 2, this condition is indicated by the box labeled “Receive Keystrokes” 202, followed by the decision box “Entry Complete” 203. Completion of “Entry Complete” 203 consists of first selecting the desired parameter address through utilization of the “Test/Up” button 101 and the “Silence/Down” button 103, followed by pressing the “Light/Select” button 102 so as to confirm selection of the displayed parameter address.

As indicated on the flow chart of FIG. 2, if “Entry Complete” 203 is “NO”, the programming interface returns to “Receive Keystrokes” 202 to await further input, and timeout will ultimately occur with a return to “RUN” mode as previously disclosed if necessary input is not provided in the allotted period of time (not shown). If “Entry Complete” 203 is “YES”, confirmed by pressing the “Light/Select” button 102, then decision box “Valid Parameter Address” 204 is accessed and the selected parameter address is validated. If the selected parameter address is determined to be invalid (“NO”), the alarm automatically returns to RUN mode. If the selected parameter address is determined to be valid (“YES”), then the “Perform Predetermined Action” 205 box is accessed and one of the following occurs in accordance with the respective parameter address selected as follows:

a) If the selected parameter address is a parameter which has an effect on entire device operation, (for example, locking the keypad to further increase security), the three digit display output means 100 reads “SET”, followed by a brief display of the selected parameter address, followed by a return to “RUN” mode and acting in accordance with the selected parameter address.

b) If the selected parameter address is for a group of other parameters which are linked together with pre-configured settings (for example, selecting a parameter for “cooler” or for “freezer” operation, which may change a number of programming parameters contained within a group simultaneously), the three digit display output means 100 reads “SET”, followed by a brief display of the selected address, followed by a return to “RUN” mode and acting in accordance with the selected parameter.

c) If the selected parameter address is for an individual parameter, contained within a group of linked configurable parameters, and is specific to a setting such as a HI alarm setpoint, the three digit display output means 100 reads “PrG” (program, as displayed with seven segment character limitations), followed by a brief display of parameter identifiers (for example, “HI” then “ALr” for high alarm temperature setting), followed by the present parameter value (for example, “42”=42 degrees). The alarm then waits in that condition for a predetermined period of time, awaiting a response from the user. If desired, the “Test/Up” button 101 and the “Silence/Down” 103 button may be utilized to change the selected parameter value. Once a desired value has been entered, the user presses and holds the “Light/Select” 102 button, the three digit display output means 100 reads “SET” and the alarm returns to “RUN” mode, retaining the last displayed parameter setting for device operation.

It is important to note that, for individual parameters contained within a group of configurable parameters, in the preferred embodiment and when in the condition as described in “c” above, a momentary press of the “Light/Select” 102 button will cause an advance to the next configurable parameter contained within the respective group and this next listed parameter will sequentially display its parameter identifiers and present parameter values as previously described. As well, the “Test/Up” button 101 and the “Silence/Down” 103 button may be utilized to change the newly selected parameter value. This is true for all configurable parameters contained within a group, with each parameter having its own unique parameter address for independent access.

Further, while it is possible to have a strictly linear parameter structure, perhaps including a “back” button to allow for backward movement through available parameters, in the preferred embodiment, all parameters contained within a group are configured as an endless loop, such that advancing from the last listed parameter address in a group continues with the first listed parameter address in the group. Still further, in the preferred embodiment, each individual parameter address is therefore an entry point into a selected group of configurable parameters. The benefit of such an architecture is that, if desired, multiple groups of configurable parameters for various purposes can be created such as a temperature alarm parameters group and a temperature control parameters group, with easy and direct access to different groups or to individual parameters contained within a respective group.

Relevant to all of the aforementioned parameter address types, if a parameter address is selected where an actual parameter exists and “Select” is not pressed within a predetermined period of time, in the preferred embodiment, the alarm will automatically timeout and return to “RUN” mode, and any changes that were made while in “PROGRAM” mode will be retained and incorporated into device operation.

In order to effectively utilize the programming interface, included within any provided instructions would be a table of parameter addresses and the functions associated with the respective parameter addresses. An example of such a table is provided below, and for the sake of clarity, an additional column is provided identifying the configuration of each type in accordance with the preceding description.

PARAMETER ADDRESS TABLE

| PARAMETER | | | |
|---|---|---|---|
| ADDRESS | FUNCTION | PARAMETER TYPE | |
| 10 | LOCK KEYPAD | AFFECTS ENTIRE DEVICE | |
| | | OPERATION | |
| 20 | COOLER | LINKED GROUP AND | |
| | PRESET, ° F. | PRECONFIGURED | |
| 21 | COOLER | LINKED GROUP AND | |
| | PRESET, ° C. | PRECONFIGURED | |
| 22 | FREEZER | LINKED GROUP AND | |
| | PRESET, ° F. | PRECONFIGURED | |
| 23 | FREEZER | LINKED GROUP AND | |
| | PRESET, ° C. | PRECONFIGURED | |
| 50 | TEMPERATURE | INDIVIDUAL | GROUP OF |
| | SCALE, ° F. | PARAMETER | LINKED |
| | OR ° C. | | CONFIGURABLE |
| 51 | HIGH ALARM | INDIVIDUAL | PARAMETERS |
| | TEMPERATURE | PARAMETER | FOR ALARM |
| | SET POINT | | |
| 52 | LOW ALARM | INDIVIDUAL | |
| | TEMPERATURE | PARAMETER | |
| | SET POINT | | |
| 53 | TEMPERATURE | INDIVIDUAL | |
| | ALARM DELAY | PARAMETER | |

| | | |
|---|---|---|
| 105 | UNLOCK | AFFECTS ENTIRE DEVICE |
| | KEYPAD | OPERATION |

This, then, completes the description of the sequence of operation of the invention.

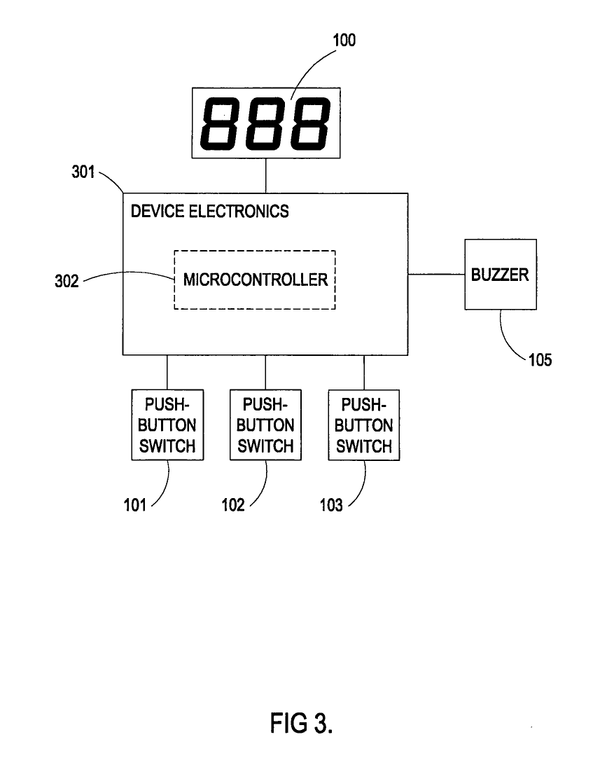

Referring to FIG. 3, this block diagram is utilized to correlate the previously disclosed method to device electronics 301 as follows: The readout 100 is the previously disclosed three digit display output means 100, push button switch 101 is the previously disclosed “Test/Up” 101 switch, push button switch 102 is the previously disclosed “Light/Select” 102 switch, push button switch 103 is the previously disclosed “Silence/Down” 103 switch, and buzzer 105 is the previously disclosed piezo or magnetic type buzzer 105. All these identified devices are connected to the device electronics of FIG. 3 and comprise the user interface of FIG. 1. The flow chart of FIG. 2 is configured as firmware and is embedded as part of device operating code in the microcontroller 302, contained within device electronics 301. All identified components and operations as previously disclosed are integrated together by the microcontroller 302 and device electronics 301 so as to perform as a cohesive whole in accordance with the previously disclosed method.

While the invention has been described in accordance with specific embodiments thereof, it is evident that many alternatives, variations and modifications will be apparent to those skilled in the art in light of the foregoing description. Alternatives, variations and modifications may include the following: While use of numeric values as parameter addresses as so described is the preferred embodiment, letters, or combinations of letters and numbers may also be utilized to greatly increase the number of possible parameter addresses if so desired. Further, rather than organizing addresses sequentially as in the preferred embodiment, it is possible as well to organize addresses, either expressed as a number or a letter, as subordinate to other addresses, again expressed as a number or a letter, as a means of greatly increasing the number of available parameter addresses, as well as greatly increasing inherent security. Further, it is even possible to have a non-uniform access means for entering various programming menus, such as utilization of different configurations of button presses for different respective menus, with further access then provided through utilization of aforementioned configurations. All of the above variations could be combined as well in various ways so as to provide alternative capabilities for the present invention. Accordingly, it is intended to embrace all such alternatives, modifications and variations as fall within the broad scope and spirit of the claims.

What is claimed is:

1. A method for selecting a set of operating parameters on a temperature alarm, said temperature alarm having as a user interface at least one or more keys and a display, comprising the steps of:
a) sensing actuation of a sequence of one or more key strokes on the user interface of said temperature alarm for the purpose of initiating a user-programming mode of operation;
b) displaying a prompt on said display of said temperature alarm for the purpose of prompting a user to enter an alphanumeric password;
c) receiving key strokes from said user in order to increment or decrement said alphanumeric password through a series of values;
d) receiving a key stroke from said user when entry of said alphanumeric password is complete;
e) testing said entered alphanumeric password against valid alphanumeric passwords; and
taking a predetermined action comprising at least installation of a set of operating parameters indexed according to the value of the alphanumeric password entered, in the case of a valid entry, or taking no action in the case of an invalid alphanumeric password entry,
wherein said set of operating parameters comprises one or more individual settings, each said individual setting controlling an aspect of the operation of said temperature alarm.

2. A method for editing at least one operating parameters on a temperature alarm, said temperature alarm having as a user interface at least one or more keys and a display, comprising the steps of:
a) sensing actuation of a sequence of one or more key strokes on the user interface of said temperature alarm for the purpose of initiating a user-programming mode of operation;
b) displaying a prompt on said display of said temperature alarm for the purpose of prompting a user to enter an alphanumeric password;
c) receiving key strokes from said user in order to increment or decrement said alphanumeric password through a series of values;
d) receiving a key stroke from said user when entry of said alphanumeric password is complete;
e) testing said entered alphanumeric password against valid alphanumeric passwords; and
f) taking a predetermined action comprising at least entry of an edit mode for user modification of at least one operating parameter indexed according to the value of the alphanumeric password entered, in the case of a valid entry, or taking no action in the case of an invalid alphanumeric password entry.

3. A method for activating diagnostic or operational functions on a temperature alarm, said temperature alarm having as a user interface at least one or more keys and a display, comprising the steps of:
a) sensing actuation of a sequence of one or more key strokes on the user interface of said temperature alarm for the purpose of initiating a user-programming mode of operation;
b) displaying a prompt on said display of said temperature alarm for the purpose of prompting a user to enter an alphanumeric password;
c) receiving key strokes from said user in order to increment or decrement said alphanumeric password through a series of values;
d) receiving a key stroke from said user when entry of said alphanumeric password is complete;
e) testing said entered alphanumeric password against valid alphanumeric passwords; and
f) taking a predetermined action comprising said diagnostic or operational functions according to the value of the alphanumeric password entered, in the case of a valid entry, or taking no action in the case of an invalid alphanumeric password entry.
